(19) United States
(12) Patent Application Publication
(10) Pub. No.: US 2016/0229336 A1
(43) Pub. Date: Aug. 11, 2016

(54) U-Turn Safety Wireless Signal System

(71) Applicant: Amr Ali, Boca Raton, FL (US)

(72) Inventor: Amr Ali, Boca Raton, FL (US)

(21) Appl. No.: 15/099,600

(22) Filed: Apr. 15, 2016

Related U.S. Application Data
(63) Continuation-in-part of application No. 14/883,625, filed on Oct. 15, 2015.
Application No. 14/883,625 is a continuation of application No. 14/689,025, filed on Apr. 16, 2015, now abandoned.
Application No. 14/689,025 is a continuation-in-part of application No. 14/480,632, filed on Sep. 8, 2014, now abandoned.
Application No. 14/480,632 is a continuation-in-part of application No. 14/161,676, filed on Jan. 22, 2014, now abandoned.

(51) Int. Cl. B60Q 1/34; B60Q 1/26

(52) U.S. Cl. CPC B60Q 1/343; B60Q 1/2696; B60Q 1/2607; B60Q 1/2615; B60Q 1/2619; B60Q 2900/10; B60Q 2900/30

(57) ABSTRACT

The invention discloses a system and method that enhances safety for vehicle before and during a U-Turn. Vehicles are equipped with retrofit U-Shape light indicator which is mounted near the left rear light of the vehicle. This light indicator is enabled wirelessly from a button mounted on the dash board by radio frequency or Bluetooth. When this U-shape indicator is turned on the driver indicates to all other drivers at the intersection that he is making a U-Turn. This in turn reduces irritation, confusion and frustration among drivers, and consequently reduces the possibility of accidents. Multiple U-Shape light indicators may be placed at different parts of the vehicle and it may be manufactured in various shapes and sizes as per the intended vehicle. Additionally, the auto-manufacturer may include the system into the car assembly and wire the button/switch to the left turn signal with a separate position for ‘U-turn’.

### CROSS REFERENCE TO RELEVANT EXISTING ART

A quick Internet search indicates that there are no such systems in the market.

A quick Patent search revealed:
Ten issued patents, all teaching of U-shape signal indicators, which are slightly different from each other.
Three of the 10 mentioned the use of wireless communication.
None mentioned the automatic shut-off of the signal, which should be the first major uniqueness of this invention.

None mentioned pairing between the transmitter and the sender to avoid cross activation between neighboring vehicles, which is a second major uniqueness of this invention.

### FEDERAL GRANTS AND SPONSORSHIP

This invention and its entire development is managed and funded by a private inventor and never connected to any Federal or State grants and/or sponsorship.

### BACKGROUND OF THE INVENTION

The invention idea is all about the safety for vehicle before and during the U-turn. Drivers when attempting to make a U-turn, normally stay in the left lane at the traffic light and turn their left signal on. All drivers in all others lanes do not know that this driver's intention is a U-turn instead of a left turn. When the left green arrow turns on, the driver proceeds with his U-Turn. which may require him to slow down for the other incoming traffic. Other drivers at the intersections may be irritated or simply change course of action and cause a traffic accident.

This invention discloses an indicator device with a U-shape arrow light that is mounted on the rear of the vehicle near the left signal light. When the driver is in the left turn lane and intends to make a U-turn, he turns it on instead of the left turn signal indicating his intended U-Turn to all drivers at the intersection. This way all drivers at the traffic intersection will anticipate his move and drive accordingly. This hopefully will make the traffic less prone to accidents. The invention may also incorporate an optional LED assembly which actually spells out a message such as “making U turn” or any other pre-stored message for safety purposes.

This U-shape indicator is a battery operated and con rolled by a wireless button mounted on the dash board inside the vehicle.

### BRIEF DESCRIPTION OF THE DRAWINGS

FIG. 1 shows the overall safeUturn system architecture.

FIG. 2 shows the Communication between the Components.

### DETAILED DESCRIPTION OF THE INVENTION

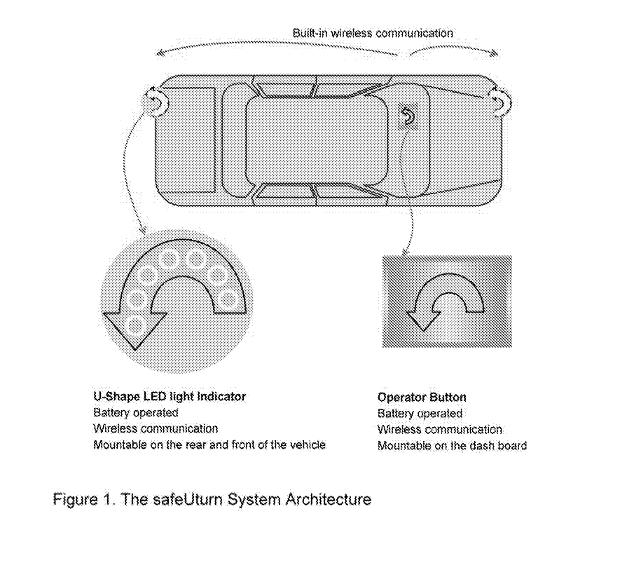

The overall system architecture is depicted in FIG. 1 with possible components. It is basically composed of two main components, the U-Turn Light Indicator (UTL) and the Operator Button (OB). Both are battery operated for ease of use as a retrofit system for existing vehicles. The concept can be still applied to new vehicle production where auto manufacturers incorporate the OB switch into the left turn signal switch (like one more click). The tin. would accordingly be built as a part of left signal light assembly.

### 1—The U-Turn Light Indicator (UTL)

This is a low-profile LED based design with light fusion lens on the top. It is:
Battery operated. The battery may he constantly charged by the addition of a solar panel, or cell.
Wireless communication (receiver) with personalization security code (automatic pairing). Radiofrequency and Bluetooth are possible technologies.
Single unit or multiple units may be activated by the same Operator Button.
Mountable on the back and/or front of the vehicle next to the left to signal light, or any other appropriate locations. Note that there can also be an indicator light on the front left and right sides as an indicator to any vehicle turning right or left from a perpendicular plane of the vehicle from a side street.
The system with the U-Shaped Light indicators may be profit by the auto-manufacturer into the existing light assemblies, in which case the communication can utilize the electrical wiring of the car, and/or be integrated with the existing left-indicator control
Inside the U-shape led design is an LED text display with 5 letters scrolling. It displays text messages in emergency cases so drivers behind the car can get some help.

### 2—The Operator Button (OB)

The operator button is a low-profile button assembly. It is:
Battery, or solar operated.
Wireless communication (transmission) with personalization security code (automatic pairing). Radiofrequency and Bluetooth are possible technologies.
Single-button user's operation for on/off and user's menu.
Manual on/off operation with max time-out timer.
Automatic shut off by a smart algorithm and hardware feedback from positional and compass sensors.
Mountable on the dashboard inside the vehicle.
The system may be prefit by the auto-manufacturer, in which case the communication can utilize the electrical wiring of the car, and/or also be activated by the left-indicator control, which could have a separate position for ‘U-turn’.
An added button to choose pre-stored messages for message display.

### 3—Communication and Control

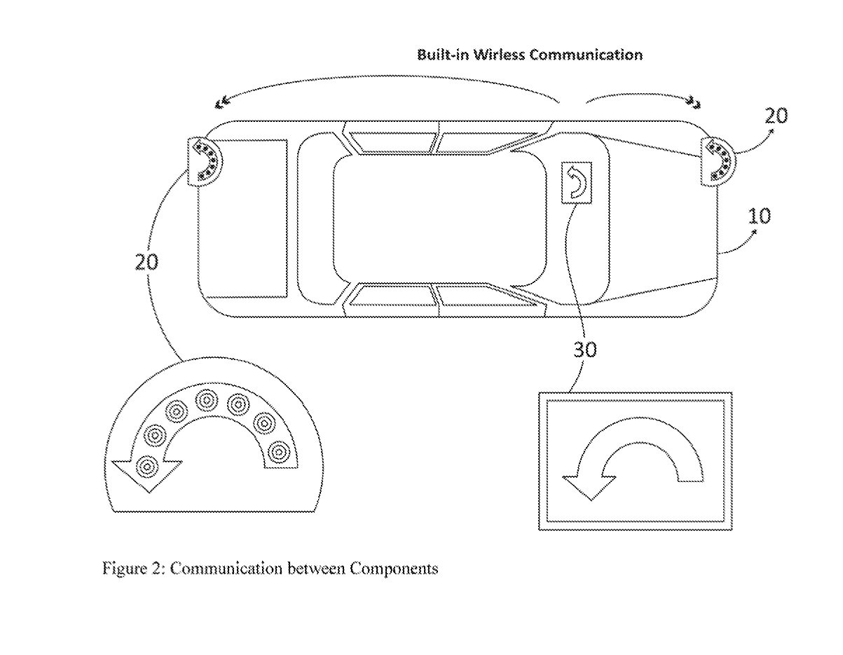

As shown in FIG. 2, the Vehicle 10, may have multiple U-Shaped Light Indicators 20 mounted, and the Operator Button 30 is coupled to these by wired or wireless communication. Wired paradigm is more likely to he used when the assembly comes pre-mounted in the vehicle. Note that the pairing using Bluetooth is less likely to cause cross interference with other proximate vehicles, users and systems. The lights may he controlled wirelessly if the system is retro-fitted and the U-Shaped Light Indicators and Operator Button are separately installed and mounted on the outside of the vehicle and dashboard separately and have less chance of utilizing the electrical components of the vehicle. A further danger indicator light may he mounted on the front left and right sides as a courtesy indicator and warning to vehicles turning right or left from a perpendicular plane of the vehicle from a side street, which would not have priority of way.

I claim:

1. A U-Turn Safety Indicator, which comprises:
a. a U-Turn Light Indicator which further comprises an LED assembly in a U-shape with a pointing arrow, a controller, a wireless receiver for operational control, and a battery compartment or solar cells; and
b. an Operator Button which further comprises a switch, a controller, a wireless transmitter, a sensor, and a battery compartment; wherein
the U-Turn Light Indicator and the Operator Button are linked by communication which may be either vi red or wireless pairing of the transmitter and receiver.

2. The U-Turn Safety Indicator of claim 1, further comprising:
A plurality of U-Turn Light Indicator units installed on the rear of the vehicle, the front of the vehicle, the front left or right side of the vehicle, and any other appropriate location on the vehicle depending on its size and shape.

3. The U-Turn Safety Indicator of claim 1, which is a retrofit system that can be mounted on exiting vehicles by means of tape, glue, magnet, or other means.

4. The U-Turn Safety Indicator of claim 1, which can be applied to new vehicle production wherein:
a. a manufacturer of the vehicle may add an additional position of click to the left turn signal switch to effectuate the switch of the Operator Button to activate said U-Turn Light Indicator,
b. the U-Turn Light Indicator is built-in as a component of the assembly of the vehicle's left signal light, and
c. the communication between Operator Button and U-Turn Light indicator may be wired or wireless pairing of the transmitter and receiver.

5. The U-Turn Safety Indicator of claim 1, which can be designed in a plurality of shapes and sizes to fit several kinds of vehicles including cars, truck and buses.

6. The U-Turn Safety Indicator of claim 1, powered by solar cells mounted on the vehicle.

7. The U-Turn Safety Indicator of claim 1, wherein the communication is wireless and implements radio frequency or Bluetooth technologies pairing of the transmitter and receiver.

8. The U-Turn Safety Indicator of claim 1, which may be automatically shut off using a smart algorithm and hardware feedback from mounted positional and compass sensors.

9. The U-Turn Safety Indicator of claim 1, further comprising an LED Assembly and text display which displays a text message stating “making U turn” and other safety-related pre-stored messages.

10. A method of enhancing road safety, which comprises the steps of:
mounting a U-Turn Safety Indicator at an appropriate place on a vehicle; the U-Turn Safety Indicator comprising:
a. a U-Turn Light Indicator Which further comprises an LED assembly in a U-shape with a pointing arrow, a controller, a wireless receiver for operational control, and a battery compartment or solar cells; and
b. an Operator Button which further comprises a switch, a controller, a wireless transmitter, a sensor, and a battery compartment;
linking by means of electronic communication the U-Turn Light Indicator and the Operator Button; wherein the communication may be either wired or wireless pairing of the transmitter and receiver, in order to control the U-Turn Light Indicator by the driver of the vehicle; and
signaling by the driver of the vehicle to other vehicles on the road prior to making a U-Turn by actuating the Operator Button in Order to enable the U-Turn Light Indicator.

11. The method of claim 10, further comprising the step of:
installing and mounting a plurality of U-Turn Light Indicator units on the rear of the vehicle, the front of the vehicle, the front left or right side of the vehicle, and any other appropriate location on the vehicle depending on its size and shape; wherein the U-Turn Safety Indicator further comprises the plurality of U-Turn Light Indicator units.

12. The method of claim 10, further comprising the step of:
mounting the U-Turn Safety Indicator as a retrofit system on exiting vehicles by means of tape, glue, magnet, or other means.

13. The method of claim 10, applied to new vehicle production further comprising the steps of:
adding by a manufacturer of the vehicle an additional position of click to the left turn signal switch of the vehicle;
effectuating the switch of the Operator Button to activate the U-Turn Light Indicator by selecting the additional position of click;
building in the U-Turn Light Indicator as a component of the assembly of the vehicle's left signal light, and
communicating between Operator Button and U-Turn Light indicator in a wired or wireless manner for pairing of the transmitter and receiver.

14. The method of claim 10, further comprising the step of:
designing the U-Turn Safety indicator in a plurality of shapes and sizes to fit several kinds of vehicles including cars, truck and buses.

15. The method of claim 10, further comprising the step of:
powered The U-Turn Safety Indicator by means of solar cells mounted on the vehicle.

16. The method of claim 10, wherein the communication, of the linking step is wireless and implements radio frequency or Bluetooth technologies for pairing of the transmitter and receiver.

17. The method of claim 10, further comprising the steps of:
mounting positional and compass sensors at an appropriate position on the vehicle;
automatically shutting off the U-Turn Safety Indicator using a smart algorithm and hardware feedback from the mounted positional and compass sensors.

18. The method of claim 10, further comprising the step of:
displaying by means of an LED Assembly and text display mounted below the U-Turn Light Indicator, a text message stating “making U turn” and other safety-related messages.
